(19) United States
(12) Patent Application Publication
(10) Pub. No.: US 2024/0149879 A1
(43) Pub. Date: May 9, 2024

(54) STEERING CONTROL DEVICE

(71) Applicant: Hino Motors, Ltd., Hino-shi (JP)

(72) Inventor: Shunsuke TSUKUDA, Hino-shi (JP)

(73) Assignee: Hino Motors, Ltd., Hino-shi (JP)

(21) Appl. No.: 18/550,141

(22) PCT Filed: Mar. 3, 2022
(86) PCT No.: PCT/JP2022/009168

§ 371 Date: Sep. 12, 2023

(30) Foreign Application Priority Data
Mar. 17, 2021 (JP) 2021-043136

(51) Int. Cl. B60W 30/18; B60W 30/12; B62D 15/02

(52) U.S. Cl. CPC B60W 30/18163; B60W 30/12; B62D 15/0255; B60W 2554/408

(57) ABSTRACT

A steering control device includes: a traveling scene determination unit which determines a traveling scene of a host vehicle; and a steering control unit which performs steering control of the host vehicle so that the host vehicle travels at a traveling position according to a traveling scene in an own lane on which the host vehicle is traveling.

### TECHNICAL FIELD

An aspect of the present invention relates to a steering control device which performs steering control of a vehicle.

### BACKGROUND ART

Patent Literature 1 describes a lane keeping system that controls a steering torque of a vehicle so that the vehicle travels on a lane center portion.

### CITATION LIST

### Patent Literature

[Patent Literature 1] Japanese Patent No. 3763211

### SUMMARY OF INVENTION

### Technical Problem

In the lane keeping system described in Patent Literature 1, steering control is performed so that the vehicle travels on a lane center portion. However, in fact, there are various traveling situations, and the traveling on the lane center portion may not be optimal depending on the traveling situation.

Therefore, an aspect of the present invention is to provide a steering control device capable of making a host vehicle to travel at a traveling position according to a traveling scene.

### Solution to Problem

A steering control device according to an aspect of the present invention includes: a traveling scene determination unit which determines a traveling scene of a host vehicle; and a steering control unit which performs steering control of the host vehicle so that the host vehicle travels at a traveling position according to the traveling scene in an own lane on which the host vehicle is traveling.

In this steering control device, since the steering control of the host vehicle is performed so that the host vehicle travels at the traveling position according to the traveling scene, the host vehicle can be made to travel at the traveling position according to the traveling scene.

The steering control device may further include an other vehicle detection unit which detects an other vehicle traveling on an adjacent lane adjacent to the own lane on which the host vehicle is traveling, the traveling scene determination unit may determine whether or not the scene is a traveling scene in which the host vehicle and the other vehicle approach each other based on a detection result of the other vehicle detection unit, and the steering control unit may perform the steering control of the host vehicle so that the host vehicle travels at a position on the side opposite to the adjacent lane on which the other vehicle is traveling in relation to a lane center of the own lane when the traveling scene determination unit determines that the scene is the traveling scene in which the host vehicle and the other vehicle approach each other. In this steering control device, since the steering control of the host vehicle is performed so that the host vehicle travels at a position on the side opposite to the adjacent lane in relation to the lane center of the own lane when the scene is the traveling scene in which the host vehicle and the other vehicle approach each other, the host vehicle can be made to travel at a position away from the other vehicle.

The steering control device may further include: a lane information acquisition unit which acquires lane information of a host vehicle traveling road on which the host vehicle is traveling; and a one-way multi-lane road determination unit which determines whether or not the host vehicle traveling road is a one-way multi-lane road having a plurality of lanes in the same traveling direction as the own lane based on the lane information acquired by the lane information acquisition unit, and when the one-way multi-lane road determination unit determines that the host vehicle traveling road is the one-way multi-lane road, the other vehicle detection unit may detect a backward traveling vehicle traveling behind the host vehicle in the same traveling direction as the host vehicle in an adjacent lane adjacent to the own lane as the other vehicle, the traveling scene determination unit may determine whether or not the scene is an overtaken traveling scene in which the host vehicle is overtaken by the backward traveling vehicle based on the detection result of the other vehicle detection unit, and the steering control unit may perform the steering control of the host vehicle so that the host vehicle travels at a position on the side opposite to the adjacent lane on which the backward traveling vehicle is traveling in relation to the lane center of the own lane when the traveling scene determination unit determines that the scene is the overtaken traveling scene. In this steering control device, since the steering control of the host vehicle is performed so that the host vehicle travels at a position on the side opposite to the adjacent lane on which the backward traveling vehicle is traveling in relation to the lane center of the own lane when the scene is the overtaken traveling scene, the host vehicle can be overtaken by the backward traveling vehicle at a position away from the backward traveling vehicle.

The steering control device may further include: a lane information acquisition unit which acquires lane information of a host vehicle traveling road on which the host vehicle is traveling; and a one-way multi-lane road determination unit which determines whether or not the host vehicle traveling road is a one-way multi-lane road having a plurality of lanes in the same traveling direction as the own lane based on the lane information acquired by the lane information acquisition unit, wherein when the one-way multi-lane road determination unit determines that the host vehicle traveling road is the one-way multi-lane road, the other vehicle detection unit may detect a forward traveling vehicle traveling in front of the host vehicle in the same traveling direction as the host vehicle in the adjacent lane adjacent to the own lane as the other vehicle, the traveling scene determination unit may determine whether or not the scene is an overtaking traveling scene in which the host vehicle overtakes the forward traveling vehicle based on the detection result of the other vehicle detection unit, and the steering control unit may perform the steering control of the host vehicle so that the host vehicle travels at a position on the side opposite to the adjacent lane on which the forward traveling vehicle is traveling in relation to the lane center of the own lane when the traveling scene determination unit determines that the scene is the overtaking traveling scene. In this steering control device, since the steering control of the host vehicle is performed so that the host vehicle travels at a position on the side opposite to the adjacent lane on which the forward traveling vehicle is traveling in relation to the lane center of the own lane when the scene is the overtaking traveling scene, the host vehicle can overtake the forward traveling vehicle at a position away from the forward traveling vehicle.

The steering control device may further include: a lane information acquisition unit which acquires lane information of a host vehicle traveling road on which the host vehicle is traveling; and a multi-lane road determination unit which determines whether or not the host vehicle traveling road is a multi-lane road having an opposite lane facing the own lane based on the lane information acquired by the lane information acquisition unit, and when the multi-lane road determination unit determines that the host vehicle traveling road is the multi-lane road, the other vehicle detection unit may detect an oncoming vehicle traveling in a direction facing the host vehicle in the opposite lane adjacent to the own lane as the other vehicle, the traveling scene determination unit may determine whether or not the scene is a passing traveling scene in which the host vehicle passes the oncoming vehicle based on the detection result of the other vehicle detection unit, and the steering control unit may perform the steering control of the host vehicle so that the host vehicle travels at a position on the side opposite to the opposite lane on which the oncoming vehicle is traveling in relation to the lane center of the own lane when the traveling scene determination unit determines that the scene is the passing traveling scene. In this steering control device, since the steering control of the host vehicle is performed so that the host vehicle travels at a position on the side opposite to the opposite lane on which the oncoming vehicle is traveling in relation to the lane center of the own lane when the scene is the passing traveling scene, the host vehicle can pass the oncoming vehicle at a position away from the oncoming vehicle.

The steering control device may further include: an other vehicle detection unit which detects an other vehicle traveling on an adjacent lane adjacent to the own lane on which the host vehicle is traveling, the traveling scene determination unit may determine whether or not the scene is a parallel traveling scene in which the host vehicle and the other vehicle travel in parallel based on a detection result of the other vehicle detection unit, and the steering control unit may perform the steering control of the host vehicle so that the host vehicle travels at a position on the side opposite to the adjacent lane on which the other vehicle is traveling in relation to a lane center of the own lane when the traveling scene determination unit determines that the scene is the parallel traveling scene. In this steering control device, since the steering control of the host vehicle is performed so that the host vehicle travels at a position on the side opposite to the adjacent lane on which the other vehicle is traveling in relation to the lane center of the own lane when the scene is the parallel traveling scene, the host vehicle can be made to travel in parallel to the other vehicle at a position away from the other vehicle.

The steering control device may further include: a lane information acquisition unit which acquires lane information of a host vehicle traveling road on which the host vehicle is traveling; a one-way multi-lane road determination unit which determines whether or not the host vehicle traveling road is a one-way multi-lane road having a plurality of lanes in the same traveling direction as the own lane based on the lane information acquired by the lane information acquisition unit; and a lane position acquisition unit which acquires a lane position of the own lane in the one-way multi-lane road when the one-way multi-lane road determination unit determines that the host vehicle is traveling on the one-way multi-lane road, the traveling scene determination unit may determine whether or not the scene is a traveling scene in which the host vehicle travels on the multi-lane road based on the determination result of the one-way multi-lane road determination unit, and the steering control unit may perform the steering control of the host vehicle so that the host vehicle travels at a position according to the lane position acquired by the lane position acquisition unit of the own lane when the traveling scene determination unit determines that the scene is the traveling scene in which the host vehicle travels on the multi-lane road. In this steering control device, since the steering control of the host vehicle is performed so that the host vehicle travels at a position according to the lane position of the own lane when the scene is the traveling scene in which the host vehicle travels on the multi-lane road, the host vehicle can be made to travel at the traveling position according to the lane position.

The traveling scene determination unit may determine whether or not the scene is an end lane traveling scene in which the host vehicle travels on an end lane located at an end side among the plurality of lanes in the same traveling direction based on the lane position of the own lane in the one-way multi-lane road acquired by the lane position acquisition unit, and the steering control unit may perform the steering control of the host vehicle so that the host vehicle travels at a position on the side opposite to a middle lane among the plurality of lanes in the same traveling direction in relation to a lane center of the own lane when the traveling scene determination unit determines that the scene is the end lane traveling scene. In this steering control device, since the steering control of the host vehicle is performed so that the host vehicle travels at a position on the side opposite to the middle lane among the plurality of lanes in the same traveling direction in relation to the lane center of the own lane when the scene is the end lane traveling scene, the host vehicle can overtake or can be overtaken by the other vehicle at a position away from the other vehicle traveling on the middle lane.

The steering control device may further include a lane change detection unit which detects a lane change of the host vehicle, the traveling scene determination unit may determine whether or not the scene is a traveling scene in which the host vehicle has changed the lane based on a detection result of the lane change detection unit, and the steering control unit may perform steering control of the host vehicle so that the host vehicle travels on a lane center portion of the own lane when the traveling scene determination unit determines that the scene is the traveling scene in which the host vehicle has changed the lane. There is a possibility that the traveling position suitable for traveling differs between the lane before the lane change and the lane after the lane change and there is a possibility that an appropriate traveling position cannot be determined immediately after changing lanes. Therefore, in this steering control device, since the steering control of the host vehicle is performed so that the host vehicle travels on the lane center portion of the own lane when the scene is the traveling scene in which the host vehicle has changed the lane, it is possible to appropriately respond to various situations after changing lanes.

### Advantageous Effects of Invention

According to an aspect of the present invention, a host vehicle can be made to travel at a traveling position according to a traveling scene.

### BRIEF DESCRIPTION OF DRAWINGS

FIG. 1 is a block configuration diagram showing a steering control device according to a first embodiment.

FIGS. 2(a) and 2(b) are schematic diagrams illustrating an example of an overtaken traveling scene.

FIGS. 3(a) and 3(b) are schematic diagrams illustrating an example of an overtaken traveling scene.

FIG. 4 is a flowchart showing a process operation of the steering control device according to the first embodiment.

FIG. 5 is a block configuration diagram showing a steering control device according to a second embodiment.

FIGS. 6(a) and 6(b) are schematic diagrams illustrating an example of an overtaking traveling scene.

FIGS. 7(a) and 7(b) are schematic diagrams illustrating an example of an overtaking traveling scene.

FIG. 8 is a flowchart showing a process operation of the steering control device according to the second embodiment.

FIG. 9 is a block configuration diagram showing a steering control device according to a third embodiment.

FIGS. 10(a) and 10(b) are schematic diagrams illustrating an example of a parallel traveling scene.

FIG. 11 is a flowchart showing a process operation of the steering control device according to the third embodiment.

FIG. 12 is a block configuration diagram showing a steering control device according to a fourth embodiment.

FIGS. 13(a), 13(b), and 13(c) are schematic diagrams illustrating an example of a passing traveling scene.

FIG. 14 is a flowchart showing a process operation of the steering control device according to the fourth embodiment.

FIG. 15 is a block configuration diagram showing a steering control device according to a fifth embodiment.

FIG. 16(a) is a schematic diagram illustrating an example of an end lane traveling scene, FIG. 16(b) is a schematic diagram illustrating an example of a middle lane traveling scene, and FIG. 16(c) is a schematic diagram illustrating an example of an end lane traveling scene.

FIG. 17 is a flowchart showing a process operation of the steering control device according to the fifth embodiment.

FIG. 18 is a block configuration diagram showing a steering control device according to a sixth embodiment.

FIGS. 19(a) and 19(b) are schematic diagrams illustrating an example of a lane change traveling scene.

FIGS. 20(a) and 20(b) are schematic diagrams illustrating an example of a lane change traveling scene.

FIG. 21 is a flowchart showing a process operation of the steering control device according to the sixth embodiment.

### DESCRIPTION OF EMBODIMENTS

Hereinafter, an embodiment of an aspect of the present invention will be described in detail with reference to the drawings. In the following description, the same or corresponding elements are denoted by the same reference numerals, and overlapping descriptions are omitted.

### First Embodiment

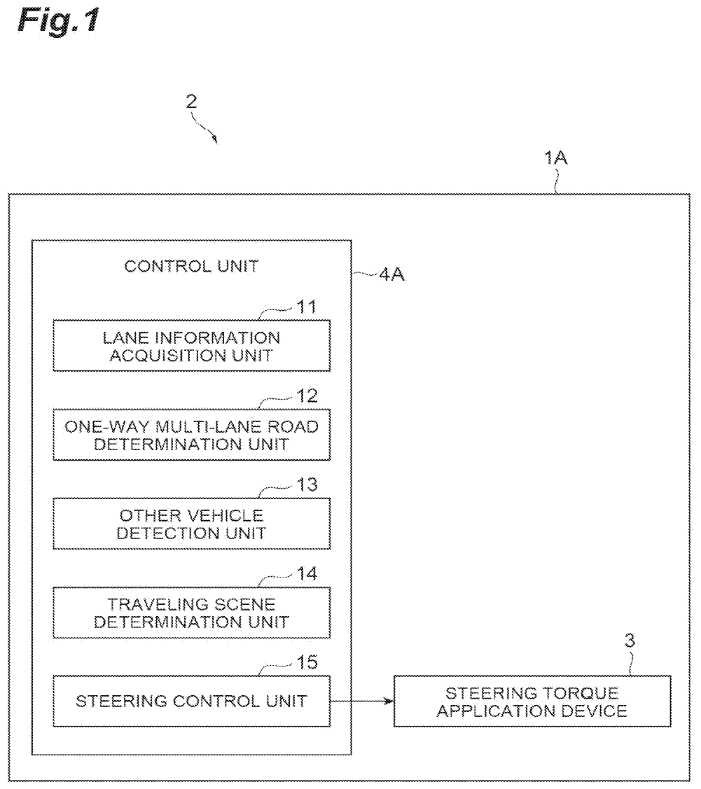

As shown in FIGS. 1 to 3, a steering control device 1A according to a first embodiment is a device which is mounted on a host vehicle 2 and performs steering control of the host vehicle 2. The steering control device 1A includes a steering torque application device 3 and a control unit 4A.

The steering torque application device 3 is a device for applying a steering torque to a handle (not shown) of the host vehicle 2. For example, the steering torque application device 3 can move (turn) the host vehicle 2 rightward by applying a rightward (clockwise) steering torque to the handle of the host vehicle 2 and can move (turn) the host vehicle 2 leftward by applying a leftward (counterclockwise) steering torque to the handle of the host vehicle 2. The steering torque application device 3 can be configured by, for example, an electric motor connected to a handle shaft (not shown) through a gear or the like.

The control unit 4A is an electronic control unit (ECU) including a CPU, ROM, RAM, and the like. In the control unit 4A, programs stored in the ROM are loaded into the RAM and executed by the CPU to perform various kinds of control. The control unit 4A may be configured by a single electronic control unit or may be configured by a plurality of electronic control units. The control unit 4A includes a lane information acquisition unit 11, a one-way multi-lane road determination unit 12, an other vehicle detection unit 13, a traveling scene determination unit 14, and a steering control unit 15. Additionally, the lane information acquisition unit 11, the one-way multi-lane road determination unit 12, the other vehicle detection unit 13, the traveling scene determination unit 14, and the steering control unit 15 may be configured by the same electronic control unit or may be configured by different electronic control units.

The lane information acquisition unit 11 acquires the lane information of a host vehicle traveling road R on which the host vehicle 2 is traveling. The lane information of the host vehicle traveling road R acquired by the lane information acquisition unit 11 includes the total number of lanes, the number of lanes in the same traveling direction as the own lane L on which the host vehicle 2 is traveling, the presence or absence of opposite lanes, the number of opposite lanes, and the like. The lane information acquisition unit 11 may acquire the lane information of the host vehicle traveling road R by any means. For example, the lane information acquisition unit 11 may acquire the lane information of the host vehicle traveling road R by specifying the position of the host vehicle 2 using GPS or the like and comparing the specified position of the host vehicle 2 with the map information. Further, the lane information acquisition unit 11 may acquire the lane information of the host vehicle traveling road R by capturing an image in the periphery of the host vehicle 2 with a camera mounted on the host vehicle 2 and analyzing the captured image to recognize the lane markings.

The one-way multi-lane road determination unit 12 determines whether or not the host vehicle traveling road R is a one-way multi-lane road based on the lane information acquired by the lane information acquisition unit 11. The one-way multi-lane road is a road having a plurality of lanes in the same traveling direction as the own lane L on which the host vehicle 2 is traveling. The same traveling direction lane is a lane which is in the same traveling direction as the own lane L and includes the own lane L. Additionally, the opposite lane does not affect the determination on whether the road is the one-way multi-lane road. That is, the one-way multi-lane road determination unit 12 determines that the road is the one-way multi-lane road if there are a plurality of lanes in the same traveling direction as the own lane L even in a road without an opposite lane or a road in which an opposite lane is a single lane.

The other vehicle detection unit 13 detects an other vehicle 20 traveling in an adjacent lane L1 adjacent to the own lane L on which the host vehicle 2 is traveling. The other vehicle detection unit 13 detects the presence of the other vehicle 20, the position of the other vehicle 20 with respect to the host vehicle 2, the relative speed of the other vehicle 20 with respect to the host vehicle 2, and the like as the other vehicle 20.

Particularly in this embodiment, the other vehicle detection unit 13 detects a backward traveling vehicle 21 traveling behind the host vehicle 2 in the same traveling direction as the host vehicle 2 in the adjacent lane L1 adjacent to the own lane L as the other vehicle 20. That is, the other vehicle detection unit 13 detects the backward traveling vehicle 21 traveling behind the host vehicle 2 in the adjacent lane L1 adjacent to the own lane L among a plurality of lanes in the same traveling direction as the other vehicle 20. The detection of the backward traveling vehicle 21 can be performed, for example, by sensing with a sensor such as a millimeter wave radar or LiDAR (Light Detection and Ranging) installed at the rear part of the host vehicle 2.

The traveling scene determination unit 14 determines the traveling scene of the host vehicle 2. More specifically, the traveling scene determination unit 14 determines whether or not the scene is the traveling scene in which the host vehicle 2 and the other vehicle 20 approach each other based on the detection result of the other vehicle detection unit 13. It is possible to determine whether or not the host vehicle 2 and the other vehicle 20 approach each other, for example, by the position, relative speed, and the like of the other vehicle 20 with respect to the host vehicle 2 detected by the other vehicle detection unit 13.

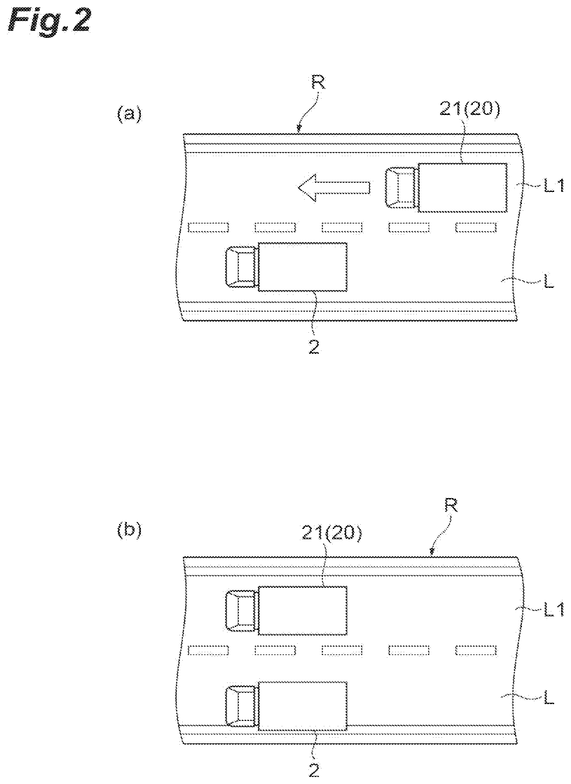

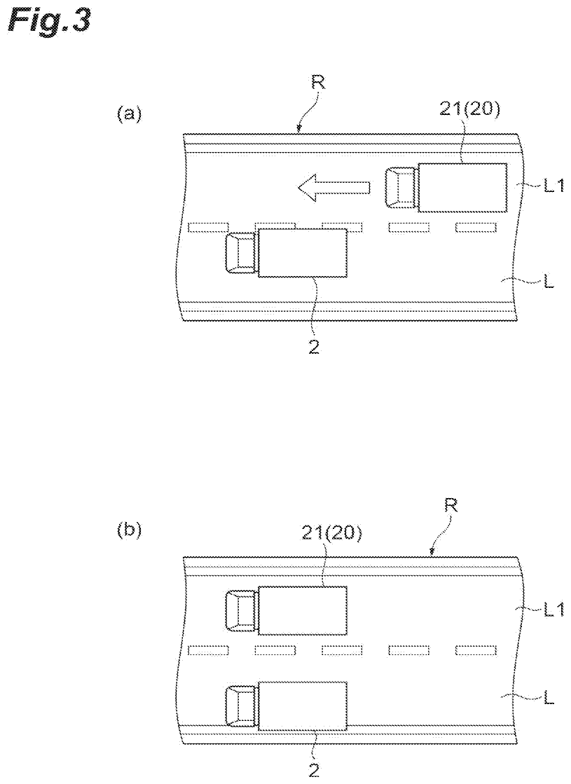

Particularly in this embodiment, the traveling scene determination unit 14 determines whether or not the scene is an overtaken traveling scene in which the host vehicle 2 is overtaken by the backward traveling vehicle 21 based on the detection result of the other vehicle detection unit 13. The overtaken traveling scene is one of the traveling scenes in which the host vehicle 2 and the other vehicle 20 approach each other. It is possible to determine whether or not the scene is the overtaken traveling scene, for example, by the position, relative speed, and the like of the backward traveling vehicle 21 with respect to the host vehicle 2 detected by the other vehicle detection unit 13. FIGS. 2(a) and 3(a) show a scene in which the backward traveling vehicle 21 travels behind the host vehicle 2 in the same traveling direction as the host vehicle 2 in the adjacent lane L1 of the own lane L among a plurality of lanes in the same traveling direction when the host vehicle traveling road R is the one-way multi-lane road having a plurality of lanes in the same traveling direction as the own lane L on which the host vehicle 2 is traveling.

The steering control unit 15 performs the steering control of the host vehicle 2 so that the host vehicle 2 travels on the own lane L at the traveling position according to the traveling scene. For example, the steering control of the host vehicle 2 is performed by controlling the steering torque application device 3 so that the host vehicle 2 travels at the target position of the own lane L in the lane width direction. That is, the steering control unit 15 controls the steering torque application device 3 so that the host vehicle 2 travels at the target position set according to the traveling scene by setting the target position according to the traveling scene. For example, the traveling position of the host vehicle 2 in the lane width direction of the own lane L can be obtained by detecting the lane markings separating the lanes using a camera (not shown), a millimeter wave sensor (not shown), and the like and calculating a positional relationship between the detected lane marking and the host vehicle 2. When the host vehicle 2 travels on the right side of the target position, the steering control unit 15 controls the steering torque application device 3 so that the host vehicle 2 moves leftward and returns the host vehicle 2 to the target position. Further, when the host vehicle 2 travels on the left side of the target position, the steering control unit 15 controls the steering torque application device 3 so that the host vehicle 2 moves rightward and returns the host vehicle 2 to the target position.

Then, when the traveling scene determination unit 14 determines that the scene is the traveling scene in which the host vehicle 2 and the other vehicle 20 approach each other, the steering control unit 15 performs the steering control of the host vehicle 2 so that the host vehicle 2 travels at a position on the side opposite to the adjacent lane L1 on which the other vehicle 20 is traveling in relation to a lane center of the own lane L (the center of the lane in the lane width direction).

Particularly in this embodiment, when the traveling scene determination unit 14 determines that the scene is the overtaken traveling scene, the steering control unit 15 performs the steering control of the host vehicle 2 so that the host vehicle 2 travels at a position on the side opposite to the adjacent lane L1 on which the backward traveling vehicle 21 is traveling in relation to the lane center of the own lane L. That is, the steering control unit 15 controls the steering torque application device 3 so that the host vehicle 2 travels at the target position by setting a position on the side opposite to the adjacent lane L1 on which the backward traveling vehicle 21 is traveling as the target position in relation to the lane center of the own lane L when the traveling scene determination unit 14 determines that the scene is the overtaken traveling scene.

For example, as shown in FIG. 2(a), the steering control unit 15 performs the steering control of the host vehicle 2 so that the host vehicle 2 travels on the lane center portion of the own lane L (the center portion of the lane in the lane width direction). In such a case, when the traveling scene determination unit 14 determines that the scene is the overtaken traveling scene, the steering control unit 15 performs the steering control of the host vehicle 2 so that the host vehicle 2 travels at a position on the side opposite to the adjacent lane L1 from the lane center of the own lane L as shown in FIG. 2(b).

Similarly, as shown in FIG. 3(a), the steering control unit 15 performs the steering control of the host vehicle 2 so that the host vehicle 2 travels on the side of the adjacent lane L1 in relation to the lane center of the own lane L. In such a case, when the traveling scene determination unit 14 determines that the scene is the overtaken traveling scene, the steering control unit 15 performs the steering control of the host vehicle 2 so that the host vehicle 2 travels at a position on the side opposite to the adjacent lane L1 in relation to the lane center of the own lane L as shown in FIG. 3(b).

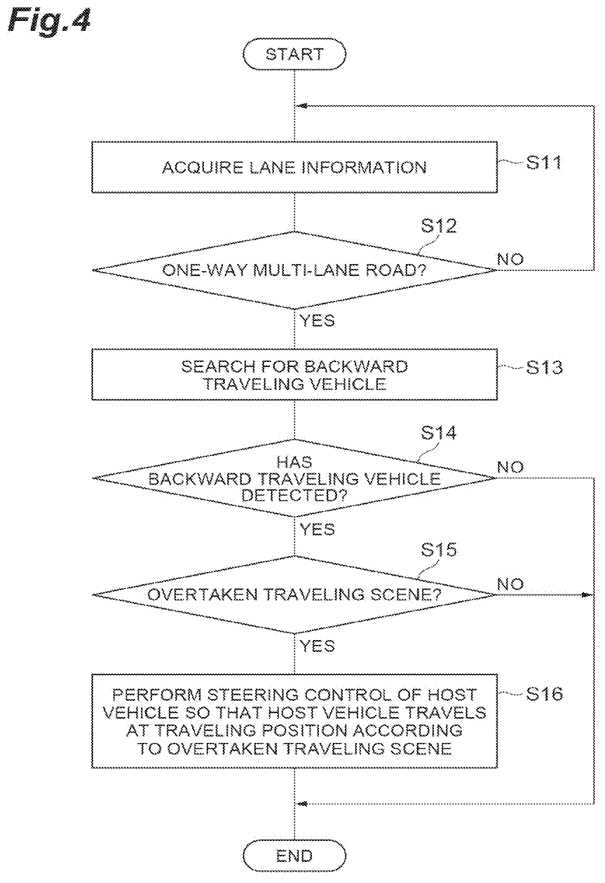

Next, an example of a process operation of the steering control device 1A will be described with reference to FIG. 4.

First, the lane information acquisition unit 11 acquires the lane information of the host vehicle traveling road R on which the host vehicle 2 is traveling (step S11). The one-way multi-lane road determination unit 12 determines whether or not the host vehicle traveling road R is the one-way multi-lane road based on the lane information acquired by the lane information acquisition unit 11 in step S11 (step S12). Steps S11 to S12 are repeated until it is determined that the host vehicle traveling road R is the one-way multi-lane road.

When it is determined that the host vehicle traveling road R is the one-way multi-lane road (step S12: YES), the other vehicle detection unit 13 searches for the backward traveling vehicle 21 traveling behind the host vehicle 2 in the same traveling direction as the host vehicle 2 in the adjacent lane L1 adjacent to the own lane L (step S13). When the backward traveling vehicle 21 is not detected in the searching of step S13 (step S14: NO), the process is ended once and the process is repeated again from step S11.

When the backward traveling vehicle 21 is detected in the searching of step S13 (step S14: YES), the traveling scene determination unit 14 determines whether or not the scene is the overtaken traveling scene in which the host vehicle 2 is overtaken by the backward traveling vehicle 21 based on the detection result of the other vehicle detection unit 13 in step S13 (step S15). When it is determined that this scene is not the overtaken traveling scene (step S15: NO), the process is ended once and the process is repeated again from step S11.

When it is determined that the scene is the overtaken traveling scene (step S15: YES), the steering control unit 15 performs the steering control of the host vehicle 2 so that the host vehicle travels at a position on the side opposite to the adjacent lane L1 on which the backward traveling vehicle 21 is traveling in relation to the lane center of the own lane L (step S16). Then, the process is ended once and the process is repeated again from step S11.

As described above, in the steering control device 1A according to this embodiment, since the steering control of the host vehicle 2 is performed so that the host vehicle travels at the traveling position according to the traveling scene of the host vehicle 2, the host vehicle 2 can be made to travel at the traveling position according to the traveling scene.

Then, the host vehicle can be made to travel at a position away from the other vehicle 20 by performing the steering control of the host vehicle 2 so that the host vehicle 2 travels at a position on the side opposite to the adjacent lane L1 in relation to the lane center of the own lane L when the scene is the traveling scene in which the host vehicle and the other vehicle 20 approach each other.

Further, the host vehicle can be overtaken by the backward traveling vehicle 21 at a position away from the backward traveling vehicle 21 by performing the steering control of the host vehicle 2 so that the host vehicle 2 travels at a position on the side opposite to the adjacent lane L1 on which the backward traveling vehicle 21 is traveling in relation to the lane center of the own lane L when the scene is the overtaken traveling scene.

### Second Embodiment

Next, a steering control device according to a second embodiment will be described. The steering control device according to the second embodiment is basically the same as the steering control device according to the first embodiment. Hereinafter, only the points different from those of the steering control device according to the first embodiment will be described and the description of the same points as those of the steering control device according to the first embodiment will be omitted.

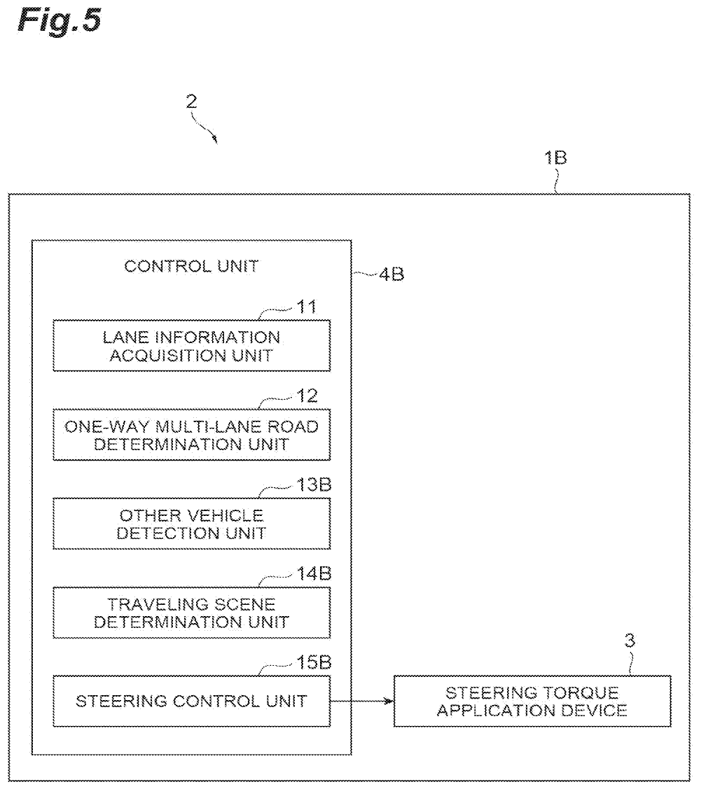

As shown in FIGS. 5 to 7, a steering control device 1B according to the second embodiment is a device which is mounted on the host vehicle 2 and performs the steering control of the host vehicle 2. The steering control device 1B includes the steering torque application device 3 and a control unit 4B.

The control unit 4B is an electronic control unit (ECU) including a CPU, ROM, RAM, and the like. In the control unit 4B, programs stored in the ROM are loaded into the RAM and executed by the CPU to perform various kinds of control. The control unit 4B may be configured by a single electronic control unit or may be configured by a plurality of electronic control units. The control unit 4B includes the lane information acquisition unit 11 which is the same as that of the first embodiment, the one-way multi-lane road determination unit 12 which is the same as that of the first embodiment, an other vehicle detection unit 13B, a traveling scene determination unit 14B, and a steering control unit 15B. Additionally, the lane information acquisition unit 11, the one-way multi-lane road determination unit 12, the other vehicle detection unit 13B, the traveling scene determination unit 14B, and the steering control unit 15B may be configured by the same electronic control unit or may be configured by different electronic control units.

The other vehicle detection unit 13B is basically the same as the other vehicle detection unit 13 of the first embodiment, but particularly in this embodiment, the other vehicle detection unit detects a forward traveling vehicle 22 traveling in front of the host vehicle 2 in the same traveling direction as the host vehicle 2 in an adjacent lane L2 adjacent to the own lane L instead of the backward traveling vehicle 21 as the other vehicle 20. That is, the other vehicle detection unit 13B detects the forward traveling vehicle 22 traveling in front of the host vehicle 2 in the adjacent lane L2 adjacent to the own lane L among a plurality of lanes in the same traveling direction as the other vehicle 20. The detection of the forward traveling vehicle 22 can be performed, for example, by sensing with a sensor such as a millimeter wave radar or LiDAR (Light Detection and Ranging) installed at the front part of the host vehicle 2.

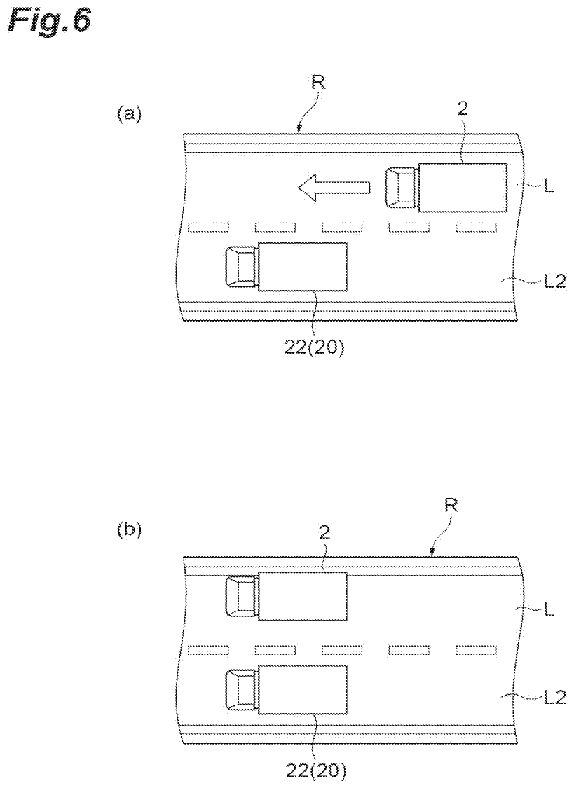

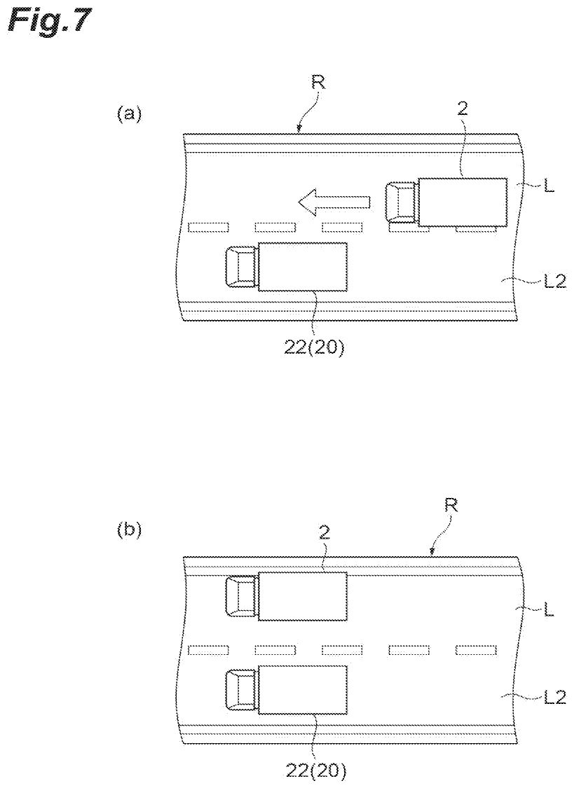

The traveling scene determination unit 14B is basically the same as the traveling scene determination unit 14 of the first embodiment, but as shown in FIGS. 6(a) and 7(a), particularly in this embodiment, the traveling scene determination unit determines whether or not the scene is an overtaking traveling scene in which the host vehicle 2 overtakes the forward traveling vehicle 22 based on the detection result of the other vehicle detection unit 13B instead of the overtaken traveling scene as the traveling scene of the host vehicle 2. The overtaking traveling scene is one of the traveling scenes in which the host vehicle 2 and the other vehicle 20 approach each other. It is possible to determine whether or not the scene is the overtaking traveling scene, for example, by the position, relative speed, and the like of the forward traveling vehicle 22 with respect to the host vehicle 2 detected by the other vehicle detection unit 13B. FIGS. 6(a) and 7(a) show a scene in which the forward traveling vehicle 22 travels in front of the host vehicle 2 in the same traveling direction as the host vehicle 2 in the adjacent lane L2 of the own lane L among a plurality of lanes in the same traveling direction when the host vehicle traveling road R is the one-way multi-lane road having a plurality of lanes in the same traveling direction as the own lane L on which the host vehicle 2 is traveling.

The steering control unit 15B is basically the same as the steering control unit 15 of the first embodiment, but particularly in this embodiment, the steering control unit performs the steering control of the host vehicle 2 so that the host vehicle 2 travels at a position on the side opposite to the adjacent lane L2 on which the forward traveling vehicle 22 is traveling in relation to the lane center of the own lane L when the traveling scene determination unit 14B determines that the scene is the overtaking traveling scene. That is, the steering control unit 15B controls the steering torque application device 3 so that the host vehicle 2 travels at the target position by setting a position on the side opposite to the adjacent lane L2 in which the forward traveling vehicle 22 is traveling in relation to the lane center of the own lane L as the target position when the traveling scene determination unit 14B determines that the scene is the overtaking traveling scene.

For example, as shown in FIG. 6(a), the steering control unit 15B performs the steering control of the host vehicle 2 so that the host vehicle 2 travels on the lane center portion of the own lane L (the center portion of the lane in the lane width direction). In such a case, when the traveling scene determination unit 14B determines that the scene is the overtaking traveling scene, the steering control unit 15B performs the steering control of the host vehicle 2 so that the host vehicle 2 travels at a position on the side opposite to the adjacent lane L2 in relation to the lane center of the own lane L as shown in FIG. 6(b).

Similarly, as shown in FIG. 7(a), the steering control unit 15B performs the steering control of the host vehicle 2 so that the host vehicle 2 travels on the side of the adjacent lane L2 in relation to the lane center of the own lane L. In such a case, when the traveling scene determination unit 14B determines that this scene is the overtaking traveling scene, the steering control unit 15B performs the steering control of the host vehicle 2 so that the host vehicle 2 travels at a position on the side opposite to the adjacent lane L2 in relation to the lane center of the own lane L as shown in FIG. 7(b).

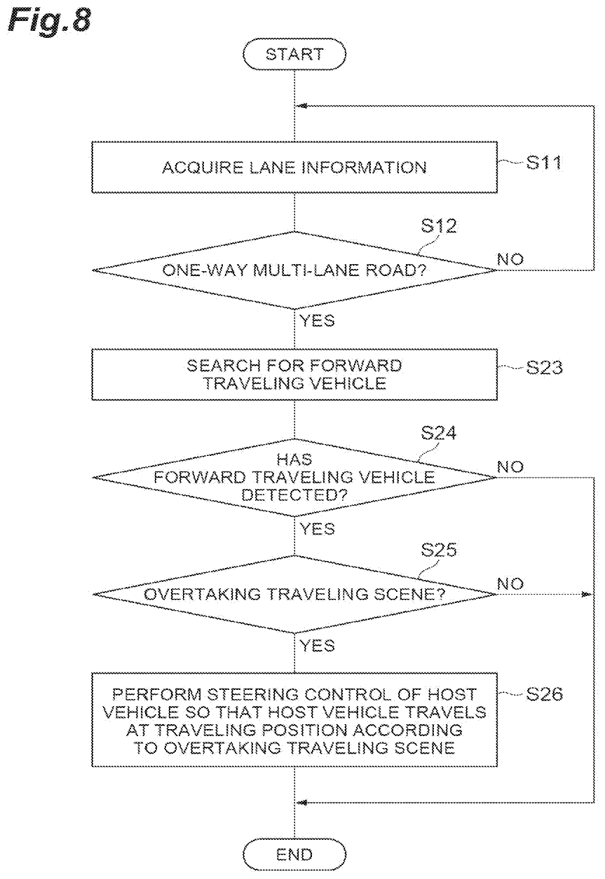

Next, an example of a process operation of the steering control device 1B will be described with reference to FIG. 8.

First, the lane information acquisition unit 11 acquires the lane information of the host vehicle traveling road R on which the host vehicle 2 is traveling (step S11). The one-way multi-lane road determination unit 12 determines whether or not the host vehicle traveling road R is the one-way multi-lane road based on the lane information acquired by the lane information acquisition unit 11 in step S11 (step S12). Steps S11 to S12 are repeated until it is determined that the host vehicle traveling road R is the one-way multi-lane road.

When it is determined that the host vehicle traveling road R is the one-way multi-lane road (step S12: YES), the other vehicle detection unit 13B searches for the forward traveling vehicle 22 traveling in front of the host vehicle 2 in the same traveling direction as the host vehicle 2 in the adjacent lane L2 adjacent to the own lane L (step S23). When the forward traveling vehicle 22 is not detected in the searching of step S23 (step S24: NO), the process is ended once and the process is repeated again from step S11.

When the forward traveling vehicle 22 is detected in the searching of step S23 (step S24: YES), the traveling scene determination unit 14B determines whether or not the scene is the overtaking traveling scene in which the host vehicle 2 overtakes the forward traveling vehicle 22 based on the detection result of the other vehicle detection unit 13 in step S23 (step S25). When it is determined that the scene is not the overtaking traveling scene (step S25: NO), the process is ended once and the process is repeated again from step S11.

When it is determined that the scene is the overtaking traveling scene (step S25: YES), the steering control unit 15B performs the steering control of the host vehicle 2 so that the host vehicle travels at a position on the side opposite to the adjacent lane L2 on which the forward traveling vehicle 22 is traveling in relation to the lane center of the own lane L (step S26). Then, the process is ended once and the process is repeated again from step S11.

As described above, in the steering control device 1B according to this embodiment, since the steering control of the host vehicle 2 is performed so that the host vehicle 2 travels at a position on the side opposite to the adjacent lane L2 in which the forward traveling vehicle 22 is traveling in relation to the lane center of the own lane L when the scene is the overtaking traveling scene, the host vehicle can overtake the forward traveling vehicle 22 at a position away from the forward traveling vehicle 22.

### Third Embodiment

Next, a steering control device according to a third embodiment will be described. The steering control device according to the third embodiment is basically the same as the steering control device according to the first embodiment. Hereinafter, only the points different from those of the steering control device according to the first embodiment will be described and the description of the same points as those of the steering control device according to the first embodiment will be omitted.

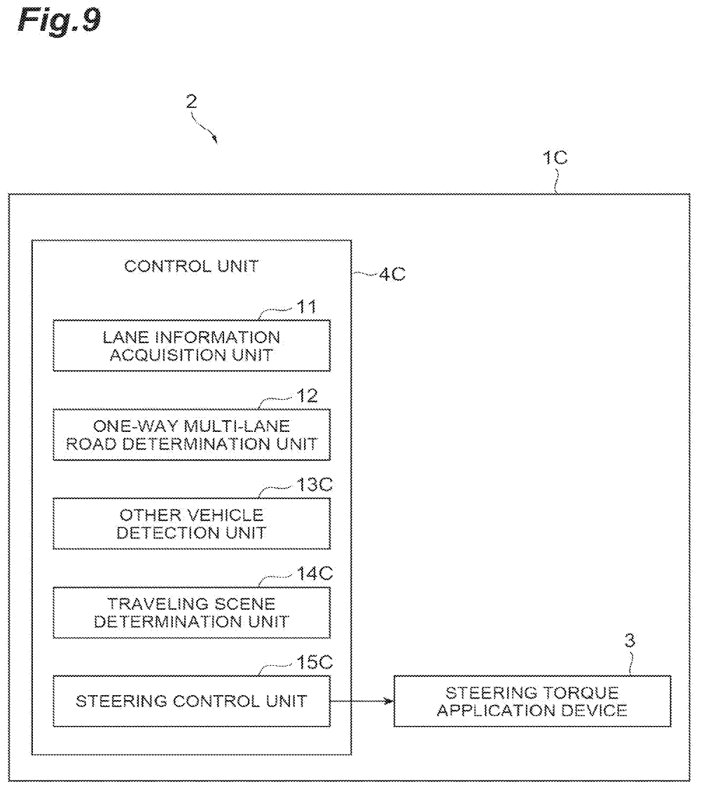

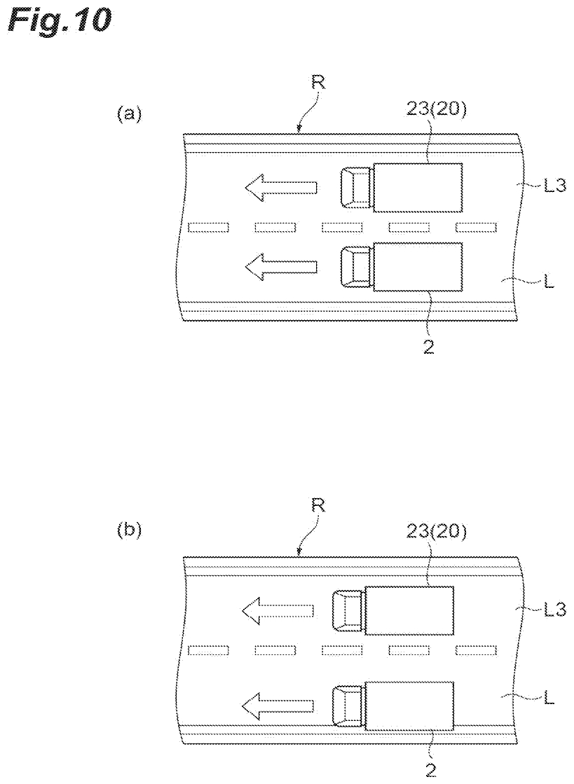

As shown in FIGS. 9 and 10, a steering control device 1C according to the third embodiment is a device which is mounted on the host vehicle 2 and performs the steering control of the host vehicle 2. The steering control device 1C includes the steering torque application device 3 and a control unit 4C.

The control unit 4C is an electronic control unit (ECU) including a CPU, ROM, RAM, and the like. In the control unit 4C, programs stored in the ROM are loaded into the RAM and executed by the CPU to perform various kinds of control. The control unit 4C may be configured by a single electronic control unit or may be configured by a plurality of electronic control units. The control unit 4C includes the lane information acquisition unit 11 which is the same as that of the first embodiment, the one-way multi-lane road determination unit 12 which is the same as that of the first embodiment, an other vehicle detection unit 13C, a traveling scene determination unit 14C, and a steering control unit 15C. Additionally, the lane information acquisition unit 11, the one-way multi-lane road determination unit 12, the other vehicle detection unit 13C, the traveling scene determination unit 14C, and the steering control unit 15C may be configured by the same electronic control unit or may be configured by different electronic control units.

The other vehicle detection unit 13C is basically the same as the other vehicle detection unit 13 of the first embodiment, but particularly in this embodiment, the other vehicle detection unit detects a parallel traveling vehicle 23 traveling in parallel to the host vehicle 2 in an adjacent lane L3 adjacent to the own lane L instead of the backward traveling vehicle 21 as the other vehicle 20. That is, the other vehicle detection unit 13C detects the parallel traveling vehicle 23 traveling on the side of the host vehicle 2 in the adjacent lane L3 adjacent to the own lane L among a plurality of lanes in the same traveling direction as the other vehicle 20. The detection of the parallel traveling vehicle 23 can be performed, for example, by sensing with a sensor such as a millimeter wave radar or LiDAR (Light Detection and Ranging) installed at the side part of the host vehicle 2.

The traveling scene determination unit 14C is basically the same as the traveling scene determination unit 14 of the first embodiment, but particularly in this embodiment, the traveling scene determination unit determines whether or not the scene is the parallel traveling scene in which the host vehicle 2 travels in parallel to the parallel traveling vehicle 23 based on the detection result of the other vehicle detection unit 13C instead of the overtaken traveling scene as the traveling scene of the host vehicle 2. It is possible to determine whether or not the scene is the parallel traveling scene, for example, by the position, relative speed, and the like of the parallel traveling vehicle 23 with respect to the host vehicle 2 detected by the other vehicle detection unit 13C. Additionally, it is determined that the host vehicle 2 and the parallel traveling vehicle 23 travel in parallel when a speed difference between the host vehicle 2 and the parallel traveling vehicle 23 is within a predetermined threshold. The predetermined threshold can be, for example, a speed difference that is generally determined to be parallel traveling. FIG. 10(a) shows a scene in which the parallel traveling vehicle 23 travels on the side of the host vehicle 2 in the same traveling direction as the host vehicle 2 in the adjacent lane L3 of the own lane L among a plurality of lanes in the same traveling direction when the host vehicle traveling road R is the one-way multi-lane road having a plurality of lanes in the same traveling direction as the own lane L on which the host vehicle 2 is traveling.

The steering control unit 15C is basically the same as the steering control unit 15 of the first embodiment, but particularly in this embodiment, the steering control of the host vehicle 2 is performed so that the host vehicle 2 travels at a position on the side opposite to the adjacent lane L3 on which the parallel traveling vehicle 23 is traveling in relation to the lane center of the own lane L when the traveling scene determination unit 14C determines that the scene is the parallel traveling scene. That is, the steering control unit 15C controls the steering torque application device 3 so that the host vehicle 2 travels at the target position by setting a position on the side opposite to the adjacent lane L3 on which the parallel traveling vehicle 23 is traveling in relation to the lane center of the own lane L as the target position when the traveling scene determination unit 14C determines that this scene is the parallel traveling scene.

For example, as shown in FIG. 10(a), the steering control unit 15C performs the steering control of the host vehicle 2 so that the host vehicle 2 travels on the lane center portion of the own lane L (the center portion of the lane in the lane width direction). In such a case, when the traveling scene determination unit 14C determines that the scene is the parallel traveling scene, the steering control unit 15C performs the steering control of the host vehicle 2 so that the host vehicle 2 travels at a position on the side opposite to the adjacent lane L3 in relation to the lane center of the own lane L as shown in FIG. 10(b).

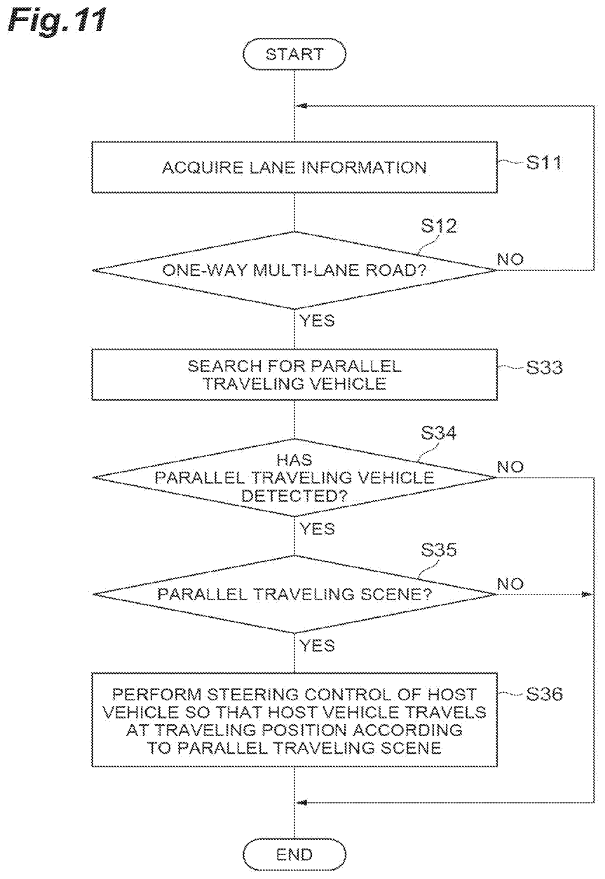

Next, an example of a process operation of the steering control device 1C will be described with reference to FIG. 11.

First, the lane information acquisition unit 11 acquires the lane information of the host vehicle traveling road R on which the host vehicle 2 is traveling (step S11). The one-way multi-lane road determination unit 12 determines whether or not the host vehicle traveling road R is the one-way multi-lane road based on the lane information acquired by the lane information acquisition unit 11 in step S11 (step S12). Steps S11 to S12 are repeated until it is determined that the host vehicle traveling road R is the one-way multi-lane road.

When it is determined that the host vehicle traveling road R is the one-way multi-lane road (step S12: YES), the other vehicle detection unit 13C searches for the parallel traveling vehicle 23 traveling parallel to the host vehicle 2 in the adjacent lane L3 adjacent to the own lane L (step S33). When the parallel traveling vehicle 23 is not detected in the searching of step S33 (step S34: NO), the process is ended once and the process is repeated again from step S11.

When the parallel traveling vehicle 23 is detected in the searching of step S33 (step S34: YES), the traveling scene determination unit 14C determines whether or not the scene is the parallel traveling scene in which the host vehicle 2 travels in parallel to the parallel traveling vehicle 23 based on the detection result of the other vehicle detection unit 13 in step S33 (step S35). When it is determined that the scene is not the parallel traveling scene (step S35: NO), the process is ended once and the process is repeated again from step S11.

When it is determined that the scene is the parallel traveling scene (step S35: YES), the steering control unit 15C performs the steering control of the host vehicle 2 so that the host vehicle travels at a position on the side opposite to the adjacent lane L3 on which the parallel traveling vehicle 23 is traveling in relation to the lane center of the own lane L (step S36). Then, the process is ended once and the process is repeated again from step S11.

As described above, in the steering control device 1C according to this embodiment, since the steering control of the host vehicle 2 is performed so that the host vehicle 2 travels at a position on the side opposite to the adjacent lane L3 in which the parallel traveling vehicle 23 is traveling in relation to the lane center of the own lane L when the scene is the parallel traveling scene, the host vehicle can travel in parallel to the parallel traveling vehicle 23 at a position away from the parallel traveling vehicle 23.

### Fourth Embodiment

Next, a steering control device according to a fourth embodiment will be described. The steering control device according to the fourth embodiment is basically the same as the steering control device according to the first embodiment. Hereinafter, only the points different from those of the steering control device according to the first embodiment will be described and the description of the same points as those of the steering control device according to the first embodiment will be omitted.

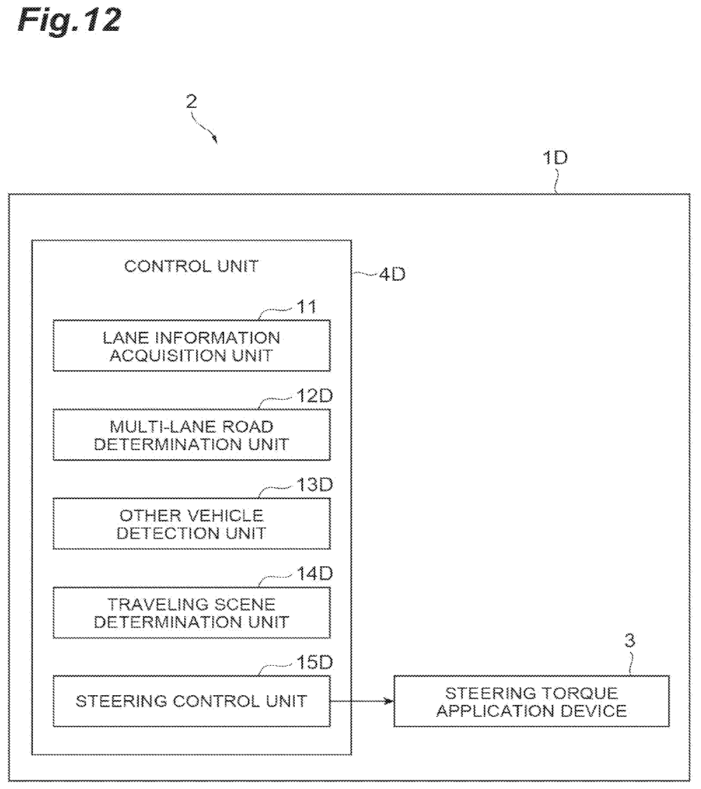

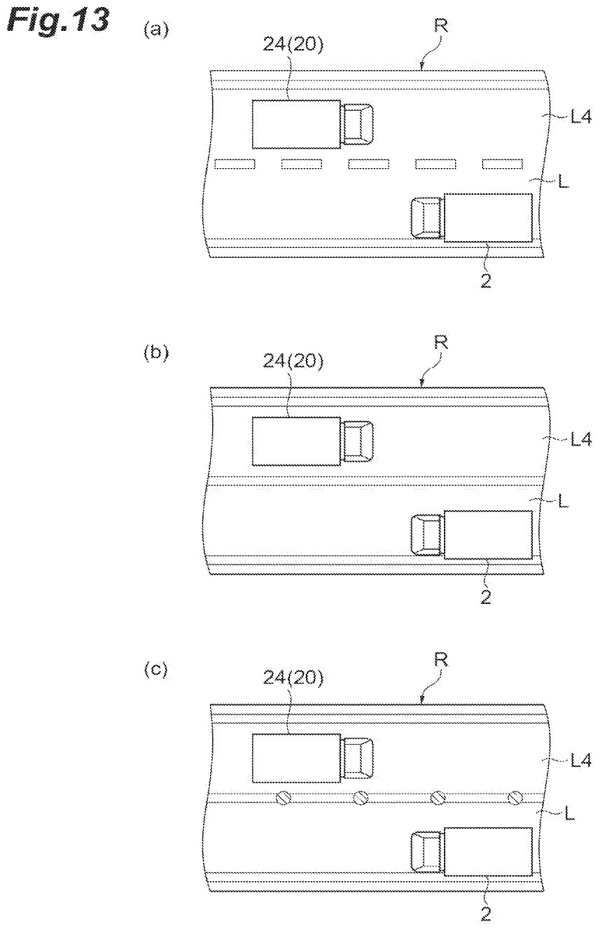

As shown in FIGS. 12 and 13, a steering control device 1D according to the fourth embodiment is a device which is mounted on the host vehicle 2 and performs the steering control of the host vehicle 2. The steering control device 1D includes the steering torque application device 3 and a control unit 4D.

The control unit 4D is an electronic control unit (ECU) including a CPU, ROM, RAM, and the like. In the control unit 4D, programs stored in the ROM are loaded into the RAM and executed by the CPU to perform various kinds of control. The control unit 4D may be configured by a single electronic control unit or may be configured by a plurality of electronic control units. The control unit 4D includes the lane information acquisition unit 11 which is the same as that of the first embodiment, a multi-lane road determination unit 12D, an other vehicle detection unit 13D, a traveling scene determination unit 14D, and a steering control unit 15D. Additionally, the lane information acquisition unit 11, the multi-lane road determination unit 12D, the other vehicle detection unit 13D, the traveling scene determination unit 14D, and the steering control unit 15D may be configured by the same electronic control unit or may be configured by different electronic control units.

The multi-lane road determination unit 12D determines whether or not the host vehicle traveling road R is the multi-lane road having an opposite lane L4 facing the own lane L based on the lane information acquired by the lane information acquisition unit 11. Additionally, whether or not there are a plurality of lanes in the same traveling direction as the own lane L does not affect the determination on whether or not the road is the multi-lane road. That is, the multi-lane road determination unit 12D determines that the road is the multi-lane road if there is the opposite lane L4 facing the own lane L in the host vehicle traveling road R even when there are not a plurality of lanes in the same traveling direction as the own lane L.

The other vehicle detection unit 13D is basically the same as the other vehicle detection unit 13 of the first embodiment, but particularly in this embodiment, the other vehicle detection unit detects an oncoming vehicle 24 traveling in a direction facing the host vehicle 2 in the opposite lane L4 adjacent to the own lane L instead of the backward traveling vehicle 21 as the other vehicle 20. The detection of the oncoming vehicle 24 can be performed, for example, by sensing with a sensor such as a millimeter wave radar or LiDAR (Light Detection and Ranging) installed at the front part of the host vehicle 2. Additionally, when the host vehicle traveling road R is the one-way multi-lane road having a plurality of lanes in the same traveling direction as the own lane L, it may be determined whether or not the own lane L is the end lane on the side of the opposite lane L4 among a plurality of lanes in the same traveling direction when detecting the oncoming vehicle 24 and the oncoming vehicle 24 may be detected when it is determined that the own lane L is the end lane. In this case, the control unit 3E may further include a lane position detection unit (not shown) and the lane position detection unit may determine whether or not the own lane L is the end lane.

The traveling scene determination unit 14D is basically the same as the traveling scene determination unit 14 of the first embodiment, but particularly in this embodiment, the traveling scene determination unit determines whether or not the scene is a passing traveling scene in which the host vehicle 2 passes the oncoming vehicle 24 based on the detection result of the other vehicle detection unit 13D instead of the overtaken traveling scene as the traveling scene of the host vehicle 2. The passing traveling scene is one of the traveling scenes in which the host vehicle 2 and the other vehicle 20 approach each other. It is possible to determine whether or not the scene is the passing traveling scene, for example, by the position, relative speed, and the like of the oncoming vehicle 24 with respect to the host vehicle 2 detected by the other vehicle detection unit 13D. FIG. 13(a) shows a scene in which the host vehicle 2 traveling on the own lane L and the oncoming vehicle 24 traveling on the opposite lane L4 pass each other on a road in which the own lane L and the opposite lane L4 are separated by dashed lane markings. FIG. 13(b) shows a scene in which the host vehicle 2 traveling on the own lane L and the oncoming vehicle 24 traveling on the opposite lane L4 pass each other on a road in which the own lane L and the opposite lane L4 are separated by the solid land markings. FIG. 13(c) shows a scene in which the host vehicle 2 traveling on the own lane L and the oncoming vehicle 24 traveling on the opposite lane L4 pass each other on a temporary public road in which the own lane L and the opposite lane L4 are separated by the land markings and the center poles.

The steering control unit 15D is basically the same as the steering control unit 15 of the first embodiment, but particularly in this embodiment, the steering control of the host vehicle 2 is performed so that the host vehicle 2 travels at a position on the side opposite to the opposite lane L4 on which the oncoming vehicle 24 is traveling in relation to the lane center of the own lane L when the traveling scene determination unit 14D determines that the scene is the passing traveling scene. That is, the steering control unit 15D controls the steering torque application device 3 so that the host vehicle 2 travels at the target position by setting a position on the side opposite to the opposite lane L4 on which the oncoming vehicle 24 is traveling in relation to the lane center of the own lane L as the target position when the traveling scene determination unit 14D determines that the scene is the passing traveling scene.

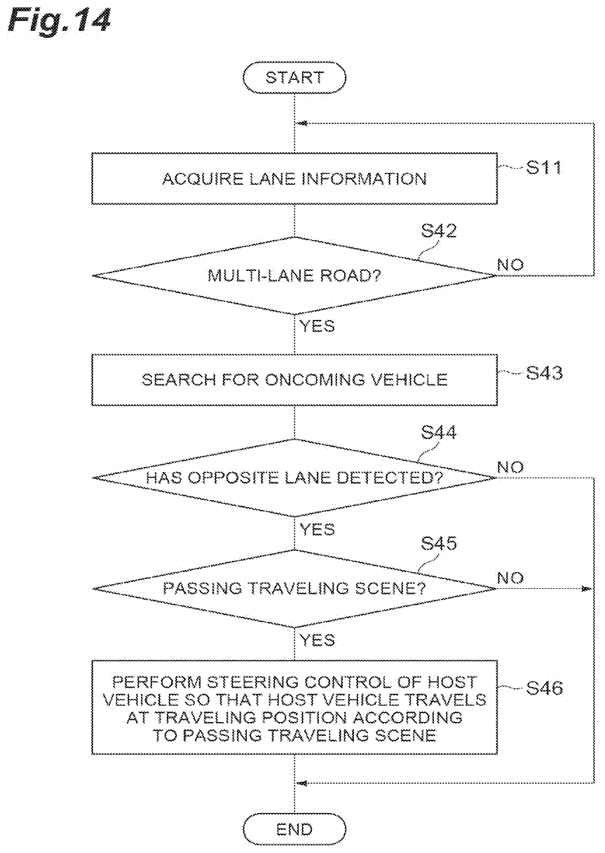

Next, an example of a process operation of the steering control device 1D will be described with reference to FIG. 14.

First, the lane information acquisition unit 11 acquires the lane information of the host vehicle traveling road R on which the host vehicle 2 is traveling (step S11). The multi-lane road determination unit 12D determines whether or not the host vehicle traveling road R is the multi-lane road based on the lane information acquired by the lane information acquisition unit 11 in step S11 (step S42). Steps S11 to S42 are repeated until it is determined that the host vehicle traveling road R is the multi-lane road.

When it is determined that the host vehicle traveling road R is the multi-lane road (step S42: YES), the other vehicle detection unit 13D searches for the oncoming vehicle 24 traveling in a direction facing the host vehicle 2 in the opposite lane L4 adjacent to the own lane L (step S43). When the oncoming vehicle 24 is not detected in the searching of step S43 (step S44: NO), the process is ended once and the process is repeated again from step S11.

When the oncoming vehicle 24 is detected in the searching of step S43 (step S44: YES), the traveling scene determination unit 14D determines whether or not the scene is the passing traveling scene in which the host vehicle 2 passes the oncoming vehicle 24 based on the detection result of the other vehicle detection unit 13 in step S43 (step S45). When it is determined that the scene is not the passing traveling scene (step S45: NO), the process is ended once and the process is repeated again from step S11.

When it is determined that the scene is the passing traveling scene (step S45: YES), the steering control unit 15D performs the steering control of the host vehicle 2 so that the host vehicle travels at a position on the side opposite to the opposite lane L4 in which the oncoming vehicle 24 is traveling in relation to the lane center of the own lane L (step S46). Then, the process is ended once and the process is repeated again from step S11.

As described above, in the steering control device 1D according to this embodiment, since the steering control of the host vehicle 2 is performed so that the host vehicle 2 travels at a position on the side opposite to the opposite lane L4 in which the oncoming vehicle 24 is traveling in relation to the lane center of the own lane L when the scene is the passing traveling scene, the host vehicle can pass the oncoming vehicle 24 at a position away from the oncoming vehicle 24.

### Fifth Embodiment

Next, a steering control device according to a fifth embodiment will be described. The steering control device according to the fifth embodiment is basically the same as the steering control device according to the first embodiment. Hereinafter, only the points different from those of the steering control device according to the first embodiment will be described and the description of the same points as those of the steering control device according to the first embodiment will be omitted.

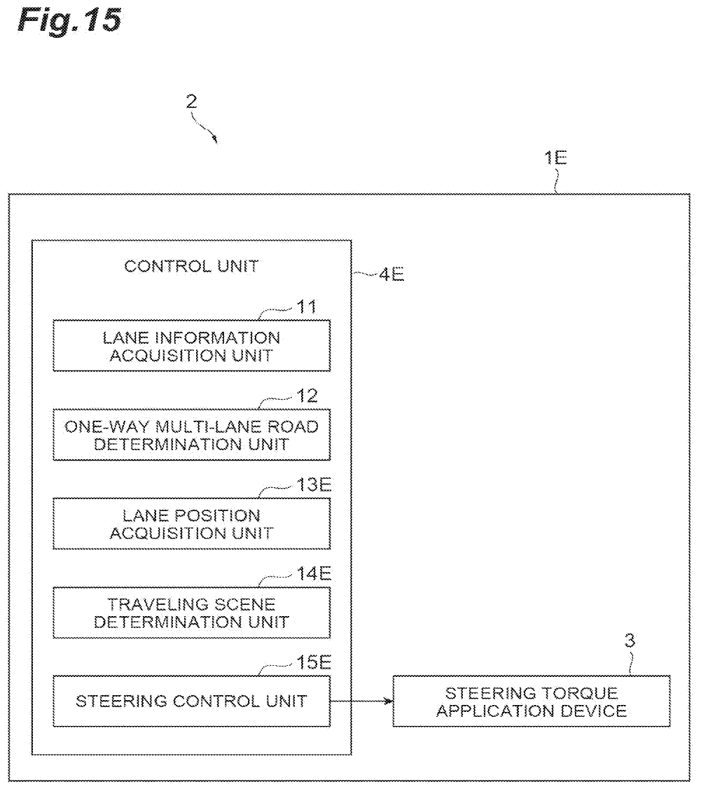

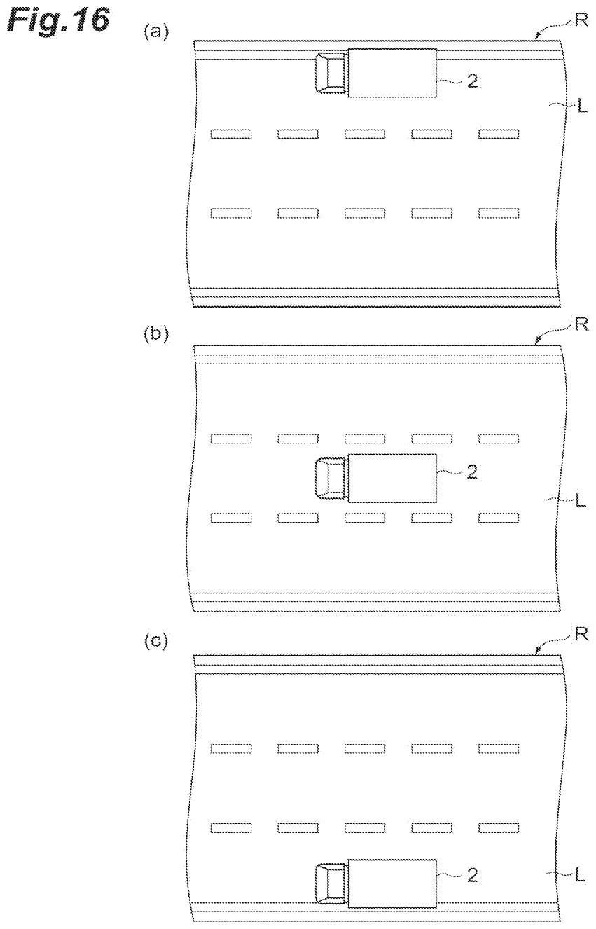

As shown in FIGS. 15 and 16, a steering control device 1E according to the fifth embodiment is a device which is mounted on the host vehicle 2 and performs the steering control of the host vehicle 2. The steering control device 1E includes the steering torque application device 3 and a control unit 4E.

The control unit 4E is an electronic control unit (ECU) including a CPU, ROM, RAM, and the like. In the control unit 4E, programs stored in the ROM are loaded into the RAM and executed by the CPU to perform various kinds of control. The control unit 4E may be configured by a single electronic control unit or may be configured by a plurality of electronic control units. The control unit 4E includes the lane information acquisition unit 11 which is the same as that of the first embodiment, the one-way multi-lane road determination unit 12 which is the same as that of the first embodiment, a lane position acquisition unit 13E, a traveling scene determination unit 14E, and a steering control unit 15E. Additionally, the lane information acquisition unit 11, the one-way multi-lane road determination unit 12, the lane position acquisition unit 13E, the traveling scene determination unit 14E, and the steering control unit 15E may be configured by the same electronic control unit or may be configured by different electronic control units.

When the one-way multi-lane road determination unit 12 determines that the host vehicle 2 travels on the one-way multi-lane road, the lane position acquisition unit 13E acquires the lane position of the own lane L in the one-way multi-lane road. Since the one-way multi-lane road is a road having a plurality of lanes in the same traveling direction as the own lane L on which the host vehicle 2 is traveling, the lane position acquisition unit 13E acquires the lane positions of a plurality of lanes in the same traveling direction as the lane position of the own lane L. More specifically, the lane position acquisition unit 13E separately acquires whether the own lane L is the end lane located at the end of the plurality of lanes in the same traveling direction or the middle lane not located at the end of the plurality of lanes in the same traveling direction. The lane position acquisition unit 13E may acquire the lane position of the own lane L by any means. For example, the lane position acquisition unit 13E may acquire the lane position of the own lane L by specifying the position of the host vehicle 2 using GPS or the like and comparing the specified position of the host vehicle 2 with the map information. Further, the lane position acquisition unit 13E may acquire the lane position of the own lane L by capturing an image in the periphery of the host vehicle 2 with a camera mounted on the host vehicle 2 and analyzing the captured image to recognize the lane markings.

The traveling scene determination unit 14E is basically the same as the traveling scene determination unit 14 of the first embodiment, but particularly in this embodiment, the traveling scene determination unit determines whether or not the scene is the traveling scene in which the host vehicle 2 travels on the multi-lane road based on the determination result of the one-way multi-lane road determination unit 12 as the traveling scene of the host vehicle 2. Further, the traveling scene determination unit 14E determines whether or not the scene is an end lane traveling scene in which the host vehicle 2 travels on the end lane located at the end side of the plurality of lanes in the same traveling direction based on the lane position of the own lane L in the one-way multi-lane road acquired by the lane position acquisition unit 13E. FIG. 16(a) shows a scene in which the host vehicle 2 travels on the end lane located at the right end among three lanes in the same traveling direction. FIG. 16(b) shows a scene in which the host vehicle 2 travels on the middle lane among three lanes in the same traveling direction. FIG. 16(c) shows a scene in which the host vehicle 2 travels on the end lane located at the left end among three lanes in the same traveling direction.

The steering control unit 15E is basically the same as the steering control unit 15 of the first embodiment, but particularly in this embodiment, the steering control of the host vehicle 2 is performed so that the host vehicle 2 travels at a position according to the lane position acquired by the lane position acquisition unit 13E of the own lane L when the traveling scene determination unit 14E determines that the scene is the traveling scene in which the host vehicle 2 travels on the multi-lane road. More specifically, as shown in FIGS. 16(a) and 16(c), when the traveling scene determination unit 14E determines that the scene is the traveling scene in which the host vehicle 2 travels on the end lane, the steering control unit 15E performs the steering control of the host vehicle 2 so that the host vehicle 2 travels at a position on the side opposite to the middle lane among a plurality of lanes in the same traveling direction in relation to the lane center of the own lane L. That is, the steering control unit 15E controls the steering torque application device 3 so that the host vehicle 2 travels at the target position by setting a position on the side opposite to the middle lane in relation to the lane center of the own lane L as the target position when the traveling scene determination unit 14B determines that the scene is the end lane traveling scene. On the other hand, as shown in FIG. 16(b), the steering control unit 15E performs the steering control of the host vehicle 2 so that the host vehicle 2 travels on the lane center portion of the own lane L when the traveling scene determination unit 14E determines that the scene is the traveling scene in which the host vehicle 2 travels on the middle lane. That is, the steering control unit 15E controls the steering torque application device 3 so that the host vehicle 2 travels at the target position by setting the lane center of the own lane L as the target position when the traveling scene determination unit 14B determines that the scene is a middle lane traveling scene.

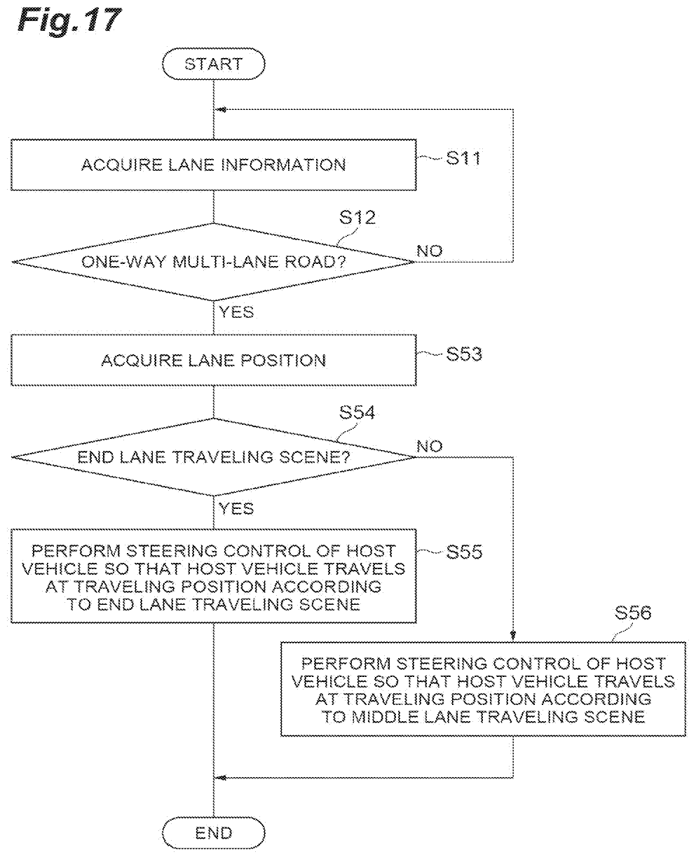

Next, an example of a process operation of the steering control device 1E will be described with reference to FIG. 17.

First, the lane information acquisition unit 11 acquires the lane information of the host vehicle traveling road R on which the host vehicle 2 is traveling (step S11). The one-way multi-lane road determination unit 12 determines whether or not the host vehicle traveling road R is the one-way multi-lane road based on the lane information acquired by the lane information acquisition unit 11 in step S11 (step S12). Steps S11 to S12 are repeated until it is determined that the host vehicle traveling road R is the one-way multi-lane road.

When it is determined that the host vehicle traveling road R is the one-way multi-lane road (step S12: YES), the lane position acquisition unit 13E acquires the lane position of the own lane L in the one-way multi-lane road (step S53). In step S53, the lane position acquisition unit separately acquires whether the own lane L is the end lane located at the end side among a plurality of lanes in the same traveling direction or the own lane L is the middle lane not located at the end side among a plurality of lanes in the same traveling direction. Then, the traveling scene determination unit 14E determines whether or not the scene is the end lane traveling scene in which the host vehicle 2 travels on the end lane located at the end side of the plurality of lanes in the same traveling direction (step S54).

When it is determined that the scene is the end lane traveling scene in which the host vehicle 2 is traveling in the end lane (step S54: YES), the steering control unit 15E performs the steering control of the host vehicle 2 so that the host vehicle 2 travels at a position on the side opposite to the middle lane among a plurality of lanes in the same traveling direction in relation to the lane center of the own lane L (step S55). On the other hand, when it is determined that the scene is not the end lane traveling scene in which the host vehicle 2 travels on the end lane, that is, when it is determined that the scene is the middle lane traveling scene in which the host vehicle 2 travels on the middle lane (step S54: NO), the steering control unit 15E performs the steering control of the host vehicle 2 so that the host vehicle 2 travels on the lane center portion of the own lane L (step S56). Then, the process is ended once and the process is repeated again from step S11.

As described above, in the steering control device 1E according to this embodiment, since the steering control of the host vehicle 2 is performed so that the host vehicle 2 travels at a position according to the lane position of the own lane L when the scene is the traveling scene in which the host vehicle 2 travels on the multi-lane road, the vehicle can be made to travel at the traveling position according to the lane position.

Then, since the steering control of the host vehicle 2 is performed so that the host vehicle 2 travels at a position on the side opposite to the middle lane among a plurality of lanes in the same traveling direction in relation to the lane center of the own lane L when the scene is the end lane traveling scene, the host vehicle can be made to overtake the other vehicle or to be overtaken by the other vehicle at a position away from the other vehicle traveling on the middle lane.

Further, since the steering control of the host vehicle 2 is performed so that the host vehicle 2 travels on the lane center portion of the own lane L when the scene is the middle lane traveling scene, the host vehicle can be made to overtake the other vehicle or to be overtaken by the other vehicle at a position away from the other vehicle traveling on the end lane.

### Sixth Embodiment

Next, a steering control device according to a sixth embodiment will be described. The steering control device according to the sixth embodiment is basically the same as the steering control device according to the first embodiment. Hereinafter, only the points different from those of the steering control device according to the first embodiment will be described and the description of the same points as those of the steering control device according to the first embodiment will be omitted.

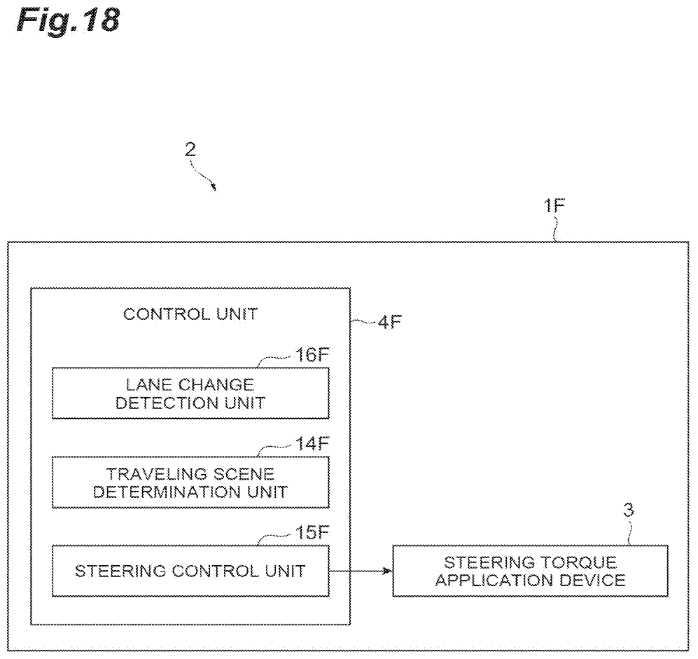

As shown in FIGS. 18 to 20, a steering control device 1F according to the sixth embodiment is a device which is mounted on the host vehicle 2 and performs the steering control of the host vehicle 2. The steering control device 1F includes the steering torque application device 3 and a control unit 4F.

The control unit 4F is an electronic control unit (ECU) including a CPU, ROM, RAM, and the like. In the control unit 4F, programs stored in the ROM are loaded into the RAM and executed by the CPU to perform various kinds of control. The control unit 4F may be configured by a single electronic control unit or may be configured by a plurality of electronic control units. The control unit 4F includes a lane change detection unit 16F, a traveling scene determination unit 14F, and a steering control unit 15F. Additionally, the lane change detection unit 16F, the traveling scene determination unit 14F, and the steering control unit 15F may be configured by the same electronic control unit or may be configured by different electronic control units.

The lane change detection unit 16F detects the lane change of the host vehicle 2. The lane change detection unit 16F may detect the lane change of the host vehicle 2 by any means. For example, the lane change detection unit 16F may acquire the lane change of the host vehicle 2 by detecting the operation and release of the turn signals of the vehicle 2. Further, the lane change detection unit 16F may acquire the lane change of the host vehicle 2 by capturing an image in the periphery of the host vehicle 2 with a camera mounted on the host vehicle 2 and analyzing the captured image to recognize the lane markings.

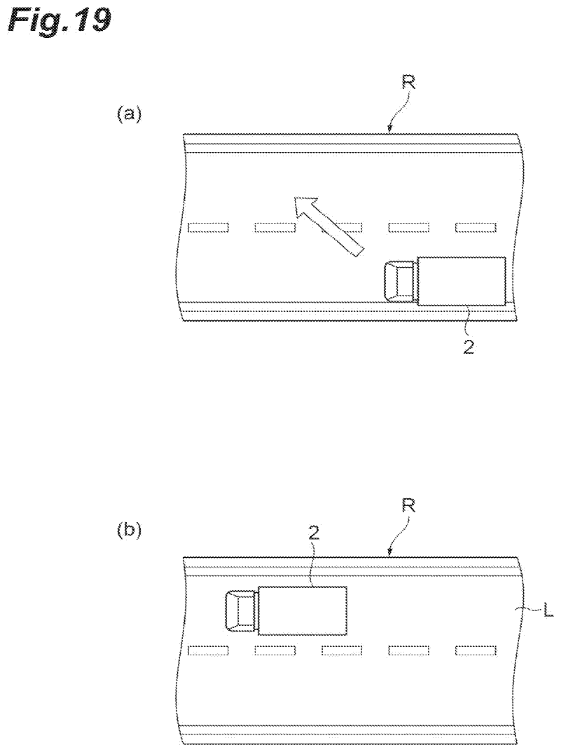

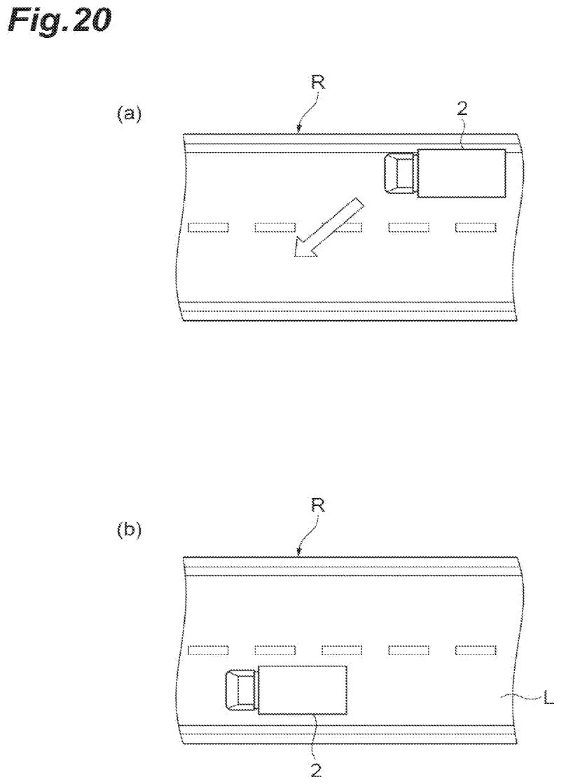

The traveling scene determination unit 14F is basically the same as the traveling scene determination unit 14 of the first embodiment, but particularly in this embodiment, the traveling scene determination unit determines whether or not the scene is the traveling scene in which the host vehicle 2 has changed the lane based on the detection result of the lane change detection unit 16F as the traveling scene of the host vehicle 2. FIGS. 19(a) and 19(b) show a traveling scene in which the host vehicle 2 traveling on the left lane changes the lane to the right lane. FIGS. 20(a) and 20(b) show a traveling scene in which the host vehicle 2 traveling on the right lane changes the lane to the left lane.

The steering control unit 15F is basically the same as the steering control unit 15 of the first embodiment. However, particularly in this embodiment, when the traveling scene determination unit 14F determines that this scene is the traveling scene in which the host vehicle 2 has changed the lane, the steering control of the host vehicle 2 is performed so that the host vehicle 2 travels on the lane center portion of the own lane L. That is, the steering control unit 15F controls the steering torque application device 3 so that the host vehicle 2 travels at the target position by setting the lane center of the own lane L as the target position when the traveling scene determination unit 14F determines that the scene is the traveling scene in which the host vehicle 2 has changed the lane.

For example, as shown in FIGS. 19(a) and 20(a), the steering control unit 15F performs the steering control of the host vehicle 2 so that the host vehicle 2 travels on the left or right side of the lane center of the own lane. Even in such a case, when the traveling scene determination unit 14 determines that the scene is the traveling scene in which the host vehicle 2 has changed the lane, the steering control unit 15 performs the steering control of the host vehicle 2 so that the host vehicle 2 travels on the lane center portion of the own lane L as shown in FIGS. 19(b) and 20(b).

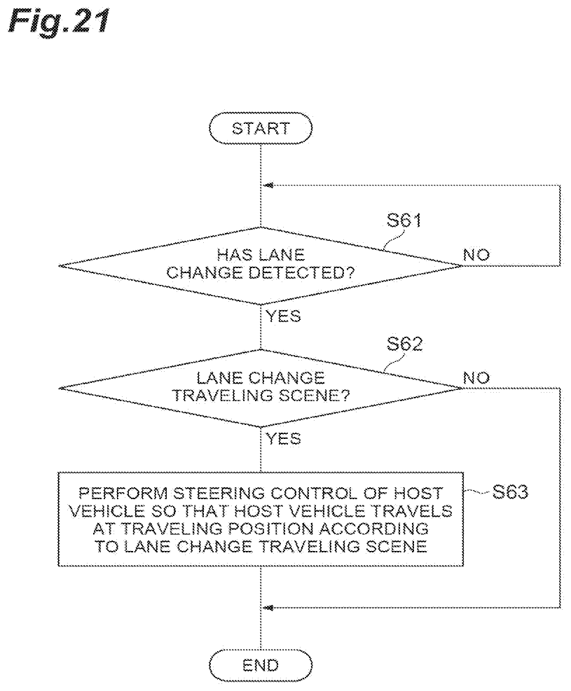

Next, an example of a process operation of the steering control device 1F will be described with reference to FIG. 21.

First, the lane change detection unit 16F determines whether or not the lane of the host vehicle 2 has changed (step S61). Step S61 is repeated until the lane of the host vehicle 2 has changed.

When it is determined that the lane of the host vehicle 2 has changed (step S61: YES), the traveling scene determination unit 14F determines whether or not the scene is the traveling scene in which the host vehicle 2 has changed the lane based on the detection result of the lane change detection unit 16F (step S62). When it is determined that the scene is not the traveling scene in which the host vehicle 2 has changed the lane (step S62: NO), the process is ended once and the process is repeated from step S61.

When it is determined that this scene is the traveling scene in which the host vehicle 2 has changed the lane (step S62: YES), the steering control unit 15F performs the steering control of the host vehicle 2 so that the host vehicle 2 travels on the lane center portion of the own lane L. Then, the process is ended once and the process is repeated again from step S61.

Incidentally, there is a possibility that the traveling position suitable for traveling differs between the lane before the lane change and the lane after the lane change and there is a possibility that an appropriate traveling position cannot be determined immediately after changing lanes. Here, in the steering control device 1F according to this embodiment, since the steering control of the host vehicle 2 is performed so that the host vehicle 2 travels on the lane center portion of the own lane L when the scene is the traveling scene in which the host vehicle 2 has changed the lane, it is possible to appropriately respond to various situations after changing lanes.

Although the embodiments of an aspect of the present invention have been described above, an aspect of the present invention is not limited to the above-described embodiments and may be modified or applied to others without changing the gist of each claim.

For example, the above-described first to sixth embodiments can be appropriately combined. For example, when the sixth embodiment is combined with the first to fifth embodiments, the host vehicle can be made to travel at the traveling position according to the traveling scene of the first to fifth embodiments before changing the lane, the host vehicle can be made to travel at the traveling position, that is, the lane center portion according to the traveling scene in which the host vehicle 2 has changed the lane immediately after changing the lane, and then the host vehicle can be made to travel at the traveling position according to the traveling scene of the first to fifth embodiments.

### REFERENCE SIGNS LIST

1A, 1B, 1C, 1D, 1E, 1F Steering control device
2 Host vehicle
3 Steering torque application device
4A, 4B, 4C, 4D, 4E, 4F Control unit
11 Lane information acquisition unit
12 One-way multi-lane road determination unit
12D Multi-lane road determination unit
13, 13B, 13C, 13D Other vehicle detection unit
13E Lane position acquisition unit
14, 14B, 14C, 14D, 14E, 14F Traveling scene determination unit
15, 15B, 15C, 15D, 15E, 15F Steering control unit
16F Lane change detection unit
20 Other vehicle
21 Backward traveling vehicle
22 Forward traveling vehicle
23 Parallel traveling vehicle
24 Oncoming vehicle
L Own lane
L1 Adjacent lane
L2 Adjacent lane
L3 Adjacent lane
L4 Opposite lane
R Host vehicle traveling road

1. A steering control device comprising:
a traveling scene determination unit which determines a traveling scene of a host vehicle; and
a steering control unit which performs steering control of the host vehicle so that the host vehicle travels at a traveling position according to the traveling scene in an own lane on which the host vehicle is traveling.

2. The steering control device according to claim 1, further comprising:
an other vehicle detection unit which detects an other vehicle traveling on an adjacent lane adjacent to the own lane on which the host vehicle is traveling,
wherein the traveling scene determination unit determines whether or not the scene is a traveling scene in which the host vehicle and the other vehicle approach each other based on a detection result of the other vehicle detection unit, and
wherein the steering control unit performs the steering control of the host vehicle so that the host vehicle travels at a position on the side opposite to the adjacent lane on which the other vehicle is traveling in relation to a lane center of the own lane when the traveling scene determination unit determines that the scene is the traveling scene in which the host vehicle and the other vehicle approach each other.

3. The steering control device according to claim 2, further comprising:
a lane information acquisition unit which acquires lane information of a host vehicle traveling road on which the host vehicle is traveling; and
a one-way multi-lane road determination unit which determines whether or not the host vehicle traveling road is a one-way multi-lane road having a plurality of lanes in the same traveling direction as the own lane based on the lane information acquired by the lane information acquisition unit,
wherein when the one-way multi-lane road determination unit determines that the host vehicle traveling road is the one-way multi-lane road, the other vehicle detection unit detects a backward traveling vehicle traveling behind the host vehicle in the same traveling direction as the host vehicle in an adjacent lane adjacent to the own lane as the other vehicle, the traveling scene determination unit determines whether or not the scene is an overtaken traveling scene in which the host vehicle is overtaken by the backward traveling vehicle based on the detection result of the other vehicle detection unit, and the steering control unit performs the steering control of the host vehicle so that the host vehicle travels at a position on the side opposite to the adjacent lane on which the backward traveling vehicle is traveling in relation to the lane center of the own lane when the traveling scene determination unit determines that the scene is the overtaken traveling scene.

4. The steering control device according to claim 2, further comprising:
a lane information acquisition unit which acquires lane information of a host vehicle traveling road on which the host vehicle is traveling; and
a one-way multi-lane road determination unit which determines whether or not the host vehicle traveling road is a one-way multi-lane road having a plurality of lanes in the same traveling direction as the own lane based on the lane information acquired by the lane information acquisition unit,
wherein when the one-way multi-lane road determination unit determines that the host vehicle traveling road is the one-way multi-lane road, the other vehicle detection unit detects a forward traveling vehicle traveling in front of the host vehicle in the same traveling direction as the host vehicle in the adjacent lane adjacent to the own lane as the other vehicle, the traveling scene determination unit determines whether or not the scene is an overtaking traveling scene in which the host vehicle overtakes the forward traveling vehicle based on the detection result of the other vehicle detection unit, and the steering control unit performs the steering control of the host vehicle so that the host vehicle travels at a position on the side opposite to the adjacent lane on which the forward traveling vehicle is traveling in relation to the lane center of the own lane when the traveling scene determination unit determines that the scene is the overtaking traveling scene.

5. The steering control device according to claim 2, further comprising:
a lane information acquisition unit which acquires lane information of a host vehicle traveling road on which the host vehicle is traveling; and
a multi-lane road determination unit which determines whether or not the host vehicle traveling road is a multi-lane road having an opposite lane facing the own lane based on the lane information acquired by the lane information acquisition unit,
wherein when the multi-lane road determination unit determines that the host vehicle traveling road is the multi-lane road, the other vehicle detection unit detects an oncoming vehicle traveling in a direction facing the host vehicle in the opposite lane adjacent to the own lane as the other vehicle, the traveling scene determination unit determines whether or not the scene is a passing traveling scene in which the host vehicle passes the oncoming vehicle based on the detection result of the other vehicle detection unit, and the steering control unit performs the steering control of the host vehicle so that the host vehicle travels at a position on the side opposite to the opposite lane on which the oncoming vehicle is traveling in relation to the lane center of the own lane when the traveling scene determination unit determines that the scene is the passing traveling scene.

6. The steering control device according to claim 1, further comprising:
an other vehicle detection unit which detects an other vehicle traveling on an adjacent lane adjacent to the own lane on which the host vehicle is traveling,
wherein the traveling scene determination unit determines whether or not the scene is a parallel traveling scene in which the host vehicle and the other vehicle travel in parallel based on a detection result of the other vehicle detection unit, and
wherein the steering control unit performs the steering control of the host vehicle so that the host vehicle travels at a position on the side opposite to the adjacent lane on which the other vehicle is traveling in relation to a lane center of the own lane when the traveling scene determination unit determines that the scene is the parallel traveling scene.

7. The steering control device according to claim 1, further comprising:
a lane information acquisition unit which acquires lane information of a host vehicle traveling road on which the host vehicle is traveling;
a one-way multi-lane road determination unit which determines whether or not the host vehicle traveling road is a one-way multi-lane road having a plurality of lanes in the same traveling direction as the own lane based on the lane information acquired by the lane information acquisition unit; and
a lane position acquisition unit which acquires a lane position of the own lane in the one-way multi-lane road when the one-way multi-lane road determination unit determines that the host vehicle is traveling on the one-way multi-lane road,
wherein the traveling scene determination unit determines whether or not the scene is a traveling scene in which the host vehicle travels on the multi-lane road based on a determination result of the one-way multi-lane road determination unit, and
wherein the steering control unit performs the steering control of the host vehicle so that the host vehicle travels at a position according to the lane position acquired by the lane position acquisition unit of the own lane when the traveling scene determination unit determines that the scene is the traveling scene in which the host vehicle travels on the multi-lane road.

8. The steering control device according to claim 7,
wherein the traveling scene determination unit determines whether or not the scene is an end lane traveling scene in which the host vehicle travels on an end lane located at an end side among the plurality of lanes in the same traveling direction based on the lane position of the own lane in the one-way multi-lane road acquired by the lane position acquisition unit, and
wherein the steering control unit performs the steering control of the host vehicle so that the host vehicle travels at a position on the side opposite to a middle lane among the plurality of lanes in the same traveling direction in relation to a lane center of the own lane when the traveling scene determination unit determines that the scene is the end lane traveling scene.

9. The steering control device according to claim 1, further comprising:
a lane change detection unit which detects a lane change of the host vehicle,
wherein the traveling scene determination unit determines whether or not the scene is a traveling scene in which the host vehicle has changed the lane based on a detection result of the lane change detection unit, and
wherein the steering control unit performs steering control of the host vehicle so that the host vehicle travels on a lane center portion of the own lane when the traveling scene determination unit determines that the scene is the traveling scene in which the host vehicle has changed the lane.
